(19) United States
(12) Patent Application Publication
(10) Pub. No.: US 2016/0240045 A1
(43) Pub. Date: Aug. 18, 2016

(54) APPLICATION FOR BABY DELIVERY POOL

(71) Applicant: Shane Doull, Bonsall, CA (US)

(72) Inventor: Shane Doull, Bonsall, CA (US)

(21) Appl. No.: 14/621,161

(22) Filed: Feb. 12, 2015

(51) Int. Cl. G07F 17/32

(52) U.S. Cl. CPC G07F 17/3244

(57) ABSTRACT

Improvements in an application for baby delivery pool for the application to be available to any family or friend that has access to a computer, tablet or smart phone. The pool aspects include, but are not limited to, birth date, birth hour, and birth minute and birth weight. The payout ratio of the winner to the expecting parents to be a variable. The variable can be from 0 to 100%. Each separate pool can have different payout percentages. The application is downloadable and interactive website where people can register and select spots in real-time as others are also selecting spots. Advertising can be used to fund the application. The advertisements are generally specific to the birth and include baby needs and or parenting needs or to a gift registry.

### CROSS REFERENCE TO RELATED APPLICATION

This application claims the benefit of Provisional Application Ser. No. 61/951,452 filed Mar. 11, 2014 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in lottery pool for determining baby delivery parameters. More particularly, the present application for baby delivery pool creates a web based pool accessible from all PC's, handheld devices and portable computing devices where different family members can join to wager on various parameters associated with the delivery of an unborn child.

2. Description of Related Art Including Information Disclosed Under 37 CFR 1.97 and 1.98

For most people the delivery of a new born baby is an experience that is shared with family members and friends. The near term randomness of an unborn child offers may variables that are difficult to predict with certainty. While a scheduled caesarian section can create a date of birth it does not definitively identify the birth weight, birth minute or a plethora of other variables. In the past family members a friends would create a matrix of one or more variables and a person would wager by entering a box and initialing the box to establish selection of this parameter. The tracking of this method requires transmitting it through fax or image to others for entry of information. The information can also be made verbally to others to select the parameter.

Gambling programs allow for masses to select any particular parameter but does not limit selection to a parameter by only one person. The odds from the masses change based upon the number people in the pool and the amount gambled on a particular spot. The profit from this type of wagering benefits the company that operates the program and the birth parents only collect on the spot(s) they bet upon.

A number of patents and or publications have been made to address these issues. Exemplary examples of patents and or publication that try to address this/these problem(s) are identified and discussed below.

Published U.S. Patent application 2004/0204217 was published on Oct. 14, 2004 for Bob Herman discloses an Event Contest Method. The application includes a contest decided by the outcome of an event includes a participant selecting a subset of predetermined size from a finite pool of event competitors. The contest uses statistical information to determine the odds. The contest can be further wagered by any number of people and the reward is derived by pooling wagers and by comparing statistics. This is not based upon a randomly occurring event such as the birth of a child and the reward is not based upon statistics.

Published U.S. Patent application 2008/0254881 was published on Oct. 16, 2008 for Howard W. Lutnick et al., discloses a Game of Chance Display. This invention allows multiple players to participate in gaming related activities using a terminal with multiple display screens. The multiple players can wager on one or more contests. The odds are based upon the number of people wagering and therefore the odds from statistics and multiple people can win a particular event. In the pending application only one person can win a particular parameter of the birth.

Published U.S. Patent application 2009/0017905 was published on Jan. 15, 2009 to Shalom Meckenzie et al., discloses a System and Method for Online Wagering. The system allows people to wager with others, at casinos and horse tracks at a distance from where the person is located. While this allows for distal wagering the wagering is based upon tickets with wagering distribution statistics.

What is needed is an application that allows family and friends to jointly select, pool, be assigned or collaborate for natural events such as birth where the outcome is essentially random. The participants can collectively contribute for the event.

### BRIEF SUMMARY OF THE INVENTION

It is an object of the application for baby delivery pool for the application to be available to any family or friend that has access to a computer, tablet or smart phone. A family of friend that has access to the technology can also enter information into the pool to further increase the number of people that can enter the pool.

It is an object of the application for baby delivery pool to offer one or more aspects of the delivery to be a part of the pool. The different aspects include, but are not limited to, birth date, birth hour, birth minute and birth weight. The pool can have exact finite elements like minutes where there are 60 finite minutes. Where there is less than the full number of entrants for a category, such as only 19 people selecting minutes, the winner can be the closest or the next highest selected value.

It is an object of the application for baby delivery pool for the payout ratio of the winner to the expecting parents to be a variable. The variable can be from 0 to 100%. At 0% the expecting parents would receive no portion of the pool. For 75% the expecting parents would receive 75% of all the pool while the winner of the pool would receive 25% of the pool. Each separate pool can have different payout percentages.

It is another object of the application for baby delivery pool to be a downloadable application or an interactive website or canvas web page where people can register and select spots in real-time as others are also select spots.

It is still another object of the application for baby delivery pool to utilize advertising to fund the pool and application. The advertisements are generally specific to the birth and include baby needs and or parenting needs. The advertising can be location specific where local stores can promote sales items and or products. A gift registry can further be available with the application where family members can purchase items or use the proceeds from the pool to purchase or contribute to the purchase of items when the pool is complete.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an overview of the connections option in the application.

FIG. 2 shows a membership sign-up page according to a preferred embodiment.

FIG. 3 shows an option page that can be selected by a user.

FIG. 4 show default pages of the application on various platforms.

FIG. 5 shows one embodiment of a Facebook interactive deployment.

### DETAILED DESCRIPTION OF THE INVENTION

The application is an online equivalent to the everyday baby pool that is played when a friend or relative becomes pregnant. Basically, people offer a few dollars to guess when a baby will be delivered or how much it will weigh and then split the pool of money. The expectant mother gains needed funds once the baby is born.

The application brings an entirely new user-experience to baby pool contests by expanding the number of people that can participate and avoiding the pitfalls with handwritten baby pools by safeguarding the funds online. With this application expectant mothers can gain money and gifts for their baby, notify friends and relatives about the upcoming birth in a fast and efficient manner and gain advice from medical experts and other moms.

The application creating a unique opportunity for friends of pregnant females to help out with the costs associated with having a newborn, help give the child a bright future by funding education and insurance, gain discounts for gifting and related products gift extra money and registry items and make the intensity of giving birth a more enjoyable experience for their friend.

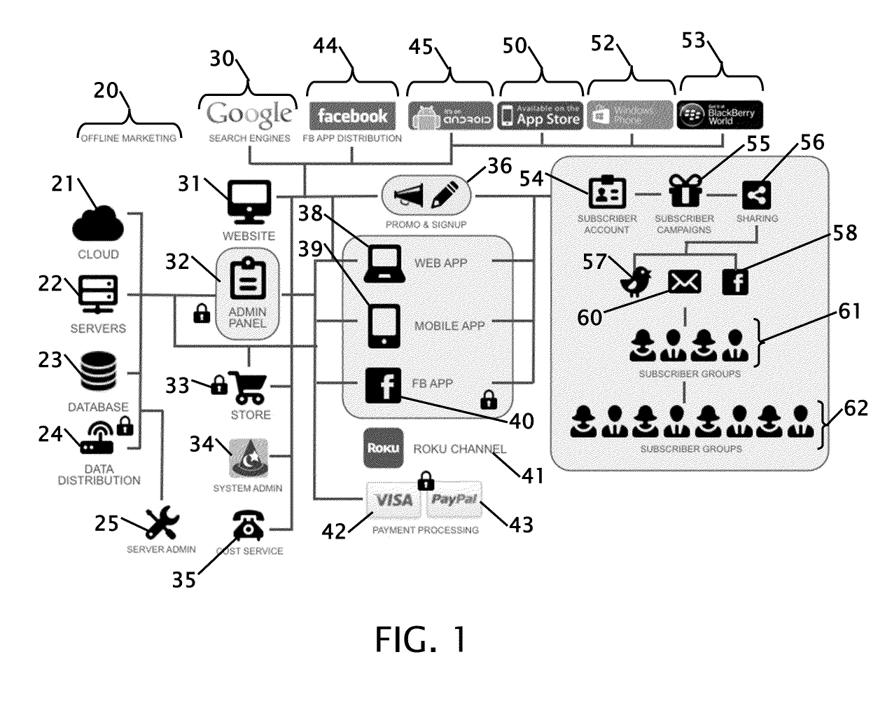

FIG. 1 shows an overview of the connections option in the application. The application provides an advertising, insurance and sales outlet for manufacturers of pregnancy/baby goods and services (targeting the 18-34 year old demographic) as well as education and parenting support group(s).

The online presence embodiment consists of a web based application running as a Php, Ruby-On-Rails, JavaScript, MySOL, HTML5 application as an on-line or offline 20 program in the cloud 21, with servers 22, a database 23 with data distribution 24. As with most programs or applications there is a server administration 25 with an administration panel 32 for system administration 34.

The application/program is contemplated to run under various computer, PC and mobile platforms including but not limited to Google 30, Facebook 44, Android 45, iOS 50, Blackberry 53, and Windows Phone 52 (smart phones and tablets). The Website 31 is responsive/CMS for signups, web app 38, Facebook 40 login and mobile app 39 downloads). The Facebook presence includes a set of Canvas app page and includes Facebook Apps Center.

The application provides a store 33 with customer service 35. Selection of the different facets of the delivery is handled within a store 33 with payment through various money handling institutions for credit card 42 and PayPal 43 or other payment processors. Credit card processing gateway and PayPal or other payments processors for all applications and funds escrow.

For each delivery the a promotion and sign-up takes place 36 where a subscriber account 54, subscriber campaign 55, and sharing 58 of the information on the delivery is communicated to participating members via various social networking platforms, including but not limited to, with twitter 57, Email 60 and Facebook 58 for communication to the subscriber groups 61 and subscriber groups 62.

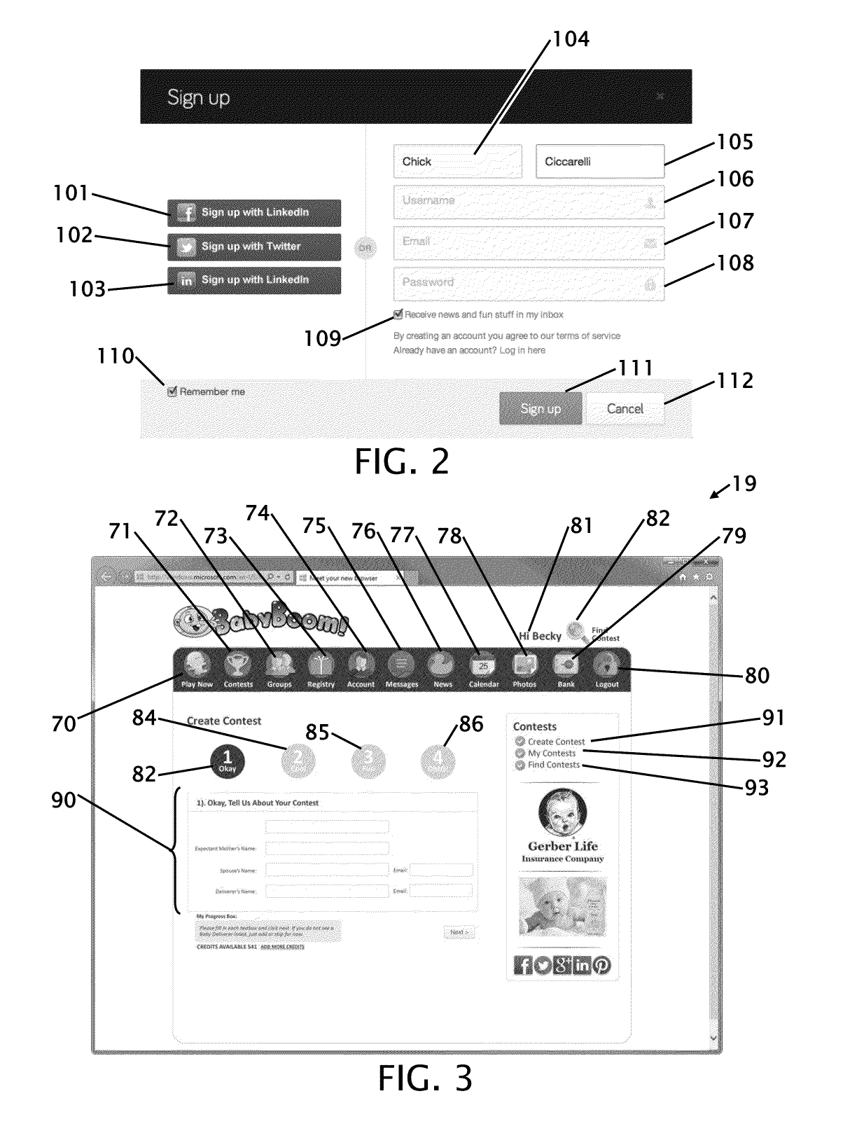

FIG. 2 shows a membership sign-up page according to a preferred embodiment. For membership sign-up, it is anticipated that the sign-up would be free for user enters that enter a registration page and fills out information in the promotional site. The user can sign-up from LinkedIn 103, Twitter 102 or a Facebook account 101 where the user information can be populated from the data of the social network site. If the user does not have a social network account the user can enter a first 104 and last name 105, create a user name 106, enter their email account (for communication regarding the delivery) and create a password 108. The user must approve of the Terms & Conditions of Web Application Usage (along with Privacy Notice and other Disclaimers i.e.: ability to invite friends from social networks) by selecting the box 109 to sign-up 111 with the account.

The application can remember 110 the entered information to reduce the time to visit the site in the future. If the user is not interested in continuing the sign-up can be canceled 112. Upon accepting the terms of the application and entering the data, i). Information is sent to application database, ii). The system emails Confirmation Email to User, iii). User must click link in email to Confirm Account registration and the iv). System sends a 2nd email Welcoming User with login access info and a quick-list of how to participate in baby pool contests. If a user already has signed-up, they may login to account area by using direct account access info or with Facebook, Twitter or LinkedIn account info. If a user signs in with social network, they are encouraged with popup to Share BabyBoomApps link with friends on network. If User has forgotten direct account info they may click Forgot Access Info, fill out a form with account email address to have access info emailed to them.

FIG. 3 shows an option page 19 that can be selected by a user. From this page a user has several choices when entering the Promo website (babyboomapps.com)—Sign-Up Free or Find a Contest (aka an existing baby pool) or Login to an existing account. Membership registration 90 allows User to create an account and use the system as a Contest Creator or a Participating Friend on other account Contests.

If the user chooses they can find a contest 93 by searching via the expectant parent(s) name and zip code, or the specific name of the contest. If it is a public contest and the user is a member already, they may openly join (and play) the Contest 92 once logged in. If the Contest is listed as Public or Private, they must Request to participate or be invited to participate by the Contest creator 91.

This page shows an initial landing page for the application with the navigation menu along the top of the page. The navigation menu allows a user options to create a contest 91 where a user can create a contest from scratch. The user can select play now 70 where the user becomes a participant to join/find an existing Contest(s). The user can select contests 71, where the can see a list of Contests they have created or joined. The user can select groups 72 where the user can create Public or Private Groups of people to email to. The user can select registration 73, the user can create, edit or find a Gift Registry. The user can select account 74, where the user can see and edit their account information. The user can select messages 75, there a user can send and receive messages related to their account from admin or friends. The user can select news 76, where a user can see messages from admin such as updates and specials. The user can selects calendar 77, where a user can see locate the dates they have chosen on a Contest. The user can select photos 78, where a user can upload and share albums and photos with friends in their Groups. And also add video links. The user can select bank 79 where a user can buy and store Boom Bucks for usage in their account. The user can select login/logout 80 where a user enter or exit their account.

To create a contest for the baby pool, once inside the User account area Dashboard, User is encouraged to start a Contest (Quick-Setup or Detailed-Setup), join a Contest or Edit an Existing Contest. To start a contest a user clicks on a button and after going through Step 1: Okay as shown below and the system automatically generates default suggestions for sections 2, 3 and 4. The Contest is saved and Contest Creator can then review it in Contest list section of Dashboard (where it awaits further instructions from User).

A user may start a contest by entering the Name of the Contest, Expectant Parents' Name and Email, the Spouse/Partner's Name and Email (optional), selecting the *Baby Bringer's Name (doctor) and Email, the approximate Date Baby Is Due, the City, State, Zip, and a Brief Highlight paragraph about the parents, baby and event in general. If the User does not find an existing Baby Bringer's info, they can type in the Baby Bringer's Name and email address and once Contest is submitted it must also send an email requesting the Baby Bringer join BabyBoom! As a Baby Bringer and participate with the contest.

A user adds Contest Details from a checkbox list of Contest Add-ons. With each pay prediction added, Contest Creator will choose the suggested minimum amount of Boom Bucks a participant must commit per guess and the maximum number of guesses allowed per participant, per day. Traditional prediction Add-ons include but are not limited to guess a baby's birth date and guessing a baby's birth time. The user can choose one or multiple times/dates and can adjust the amount of the wager/donation.

Optional side challenges can include, but not be limited to, guessing the baby's gender, guessing the baby's weight, guessing the baby's Length, guessing the baby's hair color, guessing the baby's eye color, guessing the baby's first name. As before, the user can choose one or multiple element and can adjust the amount of the wager/donation. In addition to the wagering/section, users can make a statement that participants will see other participating users of the contest, but will not be allowed to see what the predictions they have chosen.

The contest creator adds ways for participant to select gifts to be associated with the contest and a way to donate Boom Bucks or Boom Bucks winnings to baby and/or expectant parent(s). The parents can create/add a photo album(s) or video links. The contest creator may connect to previously created photo albums or video links.

Contest creator may make suggestions as to what gifts would be appropriate for a participant to select by entering keywords into a textbox separated by commas. (Note: This should be a smart box that finds pre-existing keywords from database as contest creator types). The gifts can include, but not be limited to suggestion from gifts for a baby box, suggested gifts for expectant parents box and can connect to a “My Registry” or show a link to Registry set-up, if a registry has not yet been created.

The application can include a gifted boom bucks for the baby's education fund. This allows participant to donate boom bucks to baby's education funds, insurance funds and gift cards. The winner can further designate that winnings be donated to one or both parents or any of the identified funds.

The OMG 86 contest creator reviews final contest and can go back to make a change or choose how to distribute the contest: Save, Save and Send to Groups, Save and Send a Test to Contest Creator. The save option saves the Contest for delivery at a later time where a reminder email or text message can be sent at a future date or time. The save and send to groups 72, saves and takes Contest Creator to Groups select Groups or individuals to share Contest with. This can add reminder of date, time and Group when Contest was last sent and also add a button to Send Again. A save and send a test to contest creator allows contest creator to send a test to themselves or another email address to make sure of how the email will look.

Users can join existing contest(s) where a user may view and participate with any existing contests from their My Contests list from within their account area (if User has been invited). If the User has not been invited, user may request to Participate in someone else's Contest. With each contest user is joining, they may select the traditional prediction add-ons or optional for side challenges that have been included in the contest.

Once the user has selected all the areas they wish to participate in, the Boom Bucks (credits) amount is added up much like a shopping cart, which also calculates the amount that user wishes to share with the expectant parent(s) and baby and the amount that is placed into an escrow account (which is split between the expectant parent(s) and winnings for the person with most amount of correct predictions).

In the preferred embodiment the fee amount for BabyBoomApps is not disclosed to the User. Users will not be allowed to win actual Cash. They will be able to win credits that may be used to buy things from the registry, give directly to the expectant parent(s) or newborn and donate toward the newborn insurance or education savings. The user then selects the payment method, either PayPal or Credit Card and completes the transaction. The user is emailed a confirmation of the sale.

Groups 72 of users may set up Private or Public Groups and add names and email addresses from social networks (with permission) or add names and emails manually to a particular group. Each user can invite friends from their private or public groups to promote to or communicate with. The invitation needs to be sent by email or text with a link back to the Contest or by any means with an access code to gain access to the contest.

A gift registry 73 in a typical e-commerce structure except much simpler and using credits instead of cash for checkouts. This could be tied into an open cart structure (on the Promo Site) and then pull the database from the product list into the web or mobile application for the Registry. Otherwise the gift registry will provide a list of products to add to registry from the database products uploaded from key manufacturers and/or merchants for both baby and expectant parent(s). The items can be edited or added from registry creator only. The registry can include limits on how many needed. The registry can also set level of importance: Like It, Want it, Gotta have.

For the contest participants, or general users the participant can shop just like a normal e-commerce environment except using credits. A splash page with product thumbnail listed to be listed on first page of registry section. There can be categories on side bar where users can click on a thumbnail picture of products that brings up detail page, add item(s) to a cart, add note(s) with purchase to expectant parent(s), display notices when specific products have reached the max allowed and gray out add button, perform a registry search and can select from outside the registry if not selected by the registry creator.

When an account 74 is created a user must enter a name, address, Email, phone, cell phone (sms texting), payment methods, (add address after a purchase has made to remind them to complete their details). The contest link makes available a copy and paste option to paste the image in another application or document. A block list option can block users to prevent them from sending private messages and/or completely blocking them from user's profile. Privacy settings provide various privacy settings allow members to choose what content can be viewed by other members and who can view it.

For messages 75, members can communicate with each other via private messages sent by email and posts to their Messages area. This ensures member's privacy as none of their contact data is revealed. The system will notify users of new private messages, friend requests and other important information via emails or sms text. Each user will have the ability to accept, reject or block messages coming in from other Users. Contest Creator will always be alerted when Participants are actively involved with their Contest.

News 76 allows light news, notes, specials or alerts from the admin to display in Users News section. Ability to Save or delete messages. A calendar 77 allows user to see and locate the dates they have chosen on a Contest in a monthly calendar format over a variable, fixed or selectable spread before or after the due date.

The photos 78 allow members to create multiple photo albums and upload picture to share with other members. Each album can be optionally password protected or set to be viewable only by members listed as friends including, but not limited to ultrasound, eating, visual progress reports and my belly shots. It is further contemplated that this link can include video links where members can include links from third party video sites such as youtube.com, vimeo.com, etc. Only Contest Creator decides what is uploaded or shared.

A find/search 82 allow users to filter through search results by various criteria as well as save them in their accounts.

A banking option allows user to purchase virtual currency (Boom Bucks aka credits) to purchase items on this site.

One contemplated Credit Package Example includes

$4.95=3 credits=1.65 per credit

$14.95=10 credits=1.49 per credit

$24.95=18 credits=1.38 per credit

$49.95=40 credits=1.25 per credit

$99.95=85 credits=1.17 per credit

$149.95=138 credits=1.08 per credit

Another section of the application is for doctors and or OBGYN's, identified as “Baby Bringers” where the Baby Bringers can enter or confirm the baby's delivery date and time and to join discussions relating to pregnancy and births.

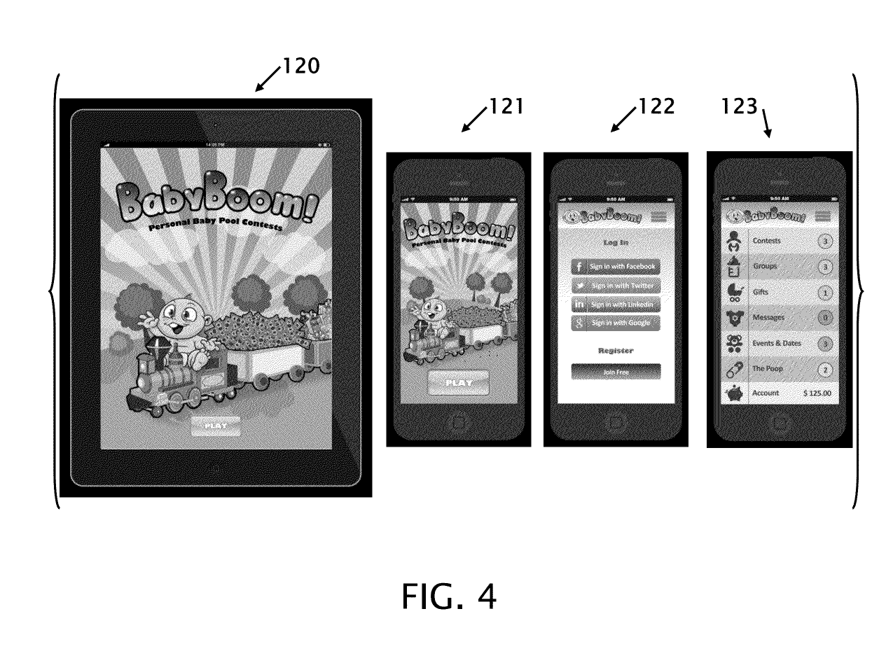

FIG. 4 show default pages of the application on various platforms. The mobile application version operates on mobile versions for tablets 120 and smart phones 121, 122 and 123 and is wrapped within the native programming framework for deployment on app stores for the following platforms: iOS, Android, Windows Phone, and Blackberry. Mobile deployment is run through Phone Aap. The features are similar in nature to the Web App.

In a Facebook interactive deployment the Facebook application is created directly within the core Facebook experience which means it will integrate with many aspects of Facebook.com, including the News Feed and Notifications. All of the core Facebook Platform technologies, such as Social Plugins, the Graph API and Platform Dialogs are utilized via Facebook's canvas pages.

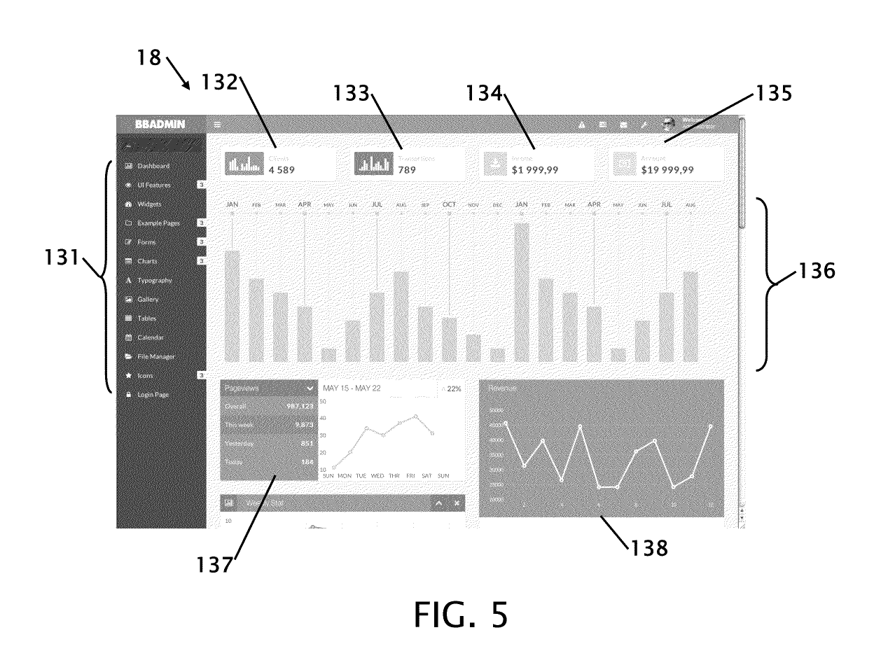

FIG. 5 shows a tracking page with an administration panel 18 that allows an administrator to manage all user info and activity (written in Php, JavaScript, HTML5 and mySQL.) This page shows options 131 along the left side of the page. The top of the page shows options for clients 132, transactions 133, and income 134 and accounts 135 where selecting these options expands a graph 136 to show detail regarding these options. The application further can track page views 137 and revenue 138 for operation of the application.

Thus, specific embodiments of an application for baby delivery pool have been disclosed. It should be apparent, however, to those skilled in the art that many more modifications besides those described are possible without departing from the inventive concepts herein. The inventive subject matter, therefore, is not to be restricted except in the spirit of the appended claims.

1. An application for a baby delivery pool comprising:
an application or program for a wagering pool for delivery from a birth;
said wagering pool includes at least two spots;
said at least two spots relate to a specific parameter of said delivery from said birth a and
at least a portion of said pool is awarded upon said delivery from said birth.

2. The application for a baby delivery pool according to claim 1 wherein said awarded amount is variable between a winner of said at least two spots and parents or owners from said birth.

3. The application for a baby delivery pool according to claim 1 wherein said application further includes advertising.

4. The application for a baby delivery pool according to claim 3 further includes a gift registry.

5. The application for a baby delivery pool according to claim 4 wherein said advertising includes a link to a store to purchase items on a gift registry.

6. The application for a baby delivery pool according to claim 1 wherein said wagering pool is selected from the group consisting of birth date, birth hour, birth minute, birth weight, a baby's Length, a baby's hair color, a baby's eye color and a baby's first name.

7. The application for a baby delivery pool according to claim 1 wherein said at least a portion of said pool is adjustable for a percentage of award that is distributed.

8. The application for a baby delivery pool according to claim 1 wherein said application or program is downloadable.

9. The application for a baby delivery pool according to claim 1 wherein said application or program operates on a cellular device, cellular phone, tablet or personal computer.

10. The application for a baby delivery pool according to claim 1 further includes a graph or chart of a size of said wagering pool.

11. The application for a baby delivery pool according to claim 1 further includes a graph or chart related to development of said an unborn baby.

12. The application for a baby delivery pool according to claim 1 further includes at least one link to a social media website.

13. The application for a baby delivery pool according to claim 1 further includes a searchable database to locate said wagering pool for delivery from said birth based upon parent name(s) and or location.

14. The application for a baby delivery pool according to claim 1 wherein said wagering pool is selectable as a public or private pool.

15. The application for a baby delivery pool according to claim 14 wherein a public pool can be for a celebrity.

16. The application for a baby delivery pool according to claim 1 wherein a registered user is able to send and receive messages related to the registered user's account from a contest administrator or friends.

17. The application for a baby delivery pool according to claim 16 wherein registered users are notified of new private messages, friend requests and information via emails or sms text.

18. The application for a baby delivery pool according to claim 1 wherein a registered user is able to create a contest for a parent of an unborn child.

19. The application for a baby delivery pool according to claim 1 further includes a suggested or a minimum contribution.

20. The application for a baby delivery pool according to claim 1 further include payment processing for funding said wagering pool.
